(19) United States
(12) Patent Application Publication
(10) Pub. No.: US 2001/0032960 A1
(43) Pub. Date: Oct. 25, 2001

(54) Fire extinguishing methods and blends utilizing unsaturated perfluorocarbons

(76) Inventors: Lawrence Robert Grzyll, Merritt Island, FL (US); Dwight Douglas Back, Melbourne, FL (US); Charlie Ramos, Satellite Beach, FL (US); Nidal Abdul Samad, Palm Bay, FL (US)

Correspondence Address: CROWELL & MORING LLP, Intellectual Property Group, P.O. Box 14300, Washington, DC, 20044-4300, US

(21) Appl. No.: 09/500,919

(22) Filed: Feb. 9, 2000

Related U.S. Application Data
(63) Continuation of application No. 08/895,687, filed on Jul. 17, 1997.
Application No. 08/895,687 is a continuation of application No. 08/519,809, filed on Aug. 25, 1995, now abandoned.

(51) Int. Cl. A62D 1/00; A62C 2/00; C10C 1/20

(52) U.S. Cl. 252/2; 252/8; 196/46

(57) ABSTRACT

Unsaturated C₃ and C₄ perfluorocarbons are used to extinguish fires. These compounds have been found to extinguish fires as effectively as Halons with similar volatility, residue levels, materials compatibility and safety but with enhanced environmental acceptability.

### BACKGROUND AND SUMMARY OF THE INVENTION

The present invention relates to fire extinguishing methods and blends utilizing unsaturated C₃ and C₄ perfluorocarbons.

The use of halogenated chemical agents containing combinations of fluorine, chlorine, bromine, iodine, and hydrogen is well-known. The most common of these agents are Halon 1301 (CF₃Br), Halon 1211 (CF₂ClBr), and Halon 2402 (CF₂BrCF₂Br). These three agents are thought to be effective at fire extinguishment because they decompose in the fire and interfere with the normal chain reactions of the fire combustion process (i.e. they are chain terminators).

Known extinguishing agents also possess the volatility that makes them useful for total flooding applications or streaming applications in portable fire extinguishers. They are clean agents; this means that they leave no residue upon evaporation or during fire suppression. They also nonreactive to the majority of metals and nonmetals with which they come into contact with during use. They are also safe agents, having toxicity characteristics suitable for occupied spaces during their use.

These three agents are, however, believed to be capable of destroying the ozone layer. Hence, their manufacture has been banned by recent environmental regulations. They are also thought to contribute to global warming because their atmospheric lifetime is sufficiently long that they persist in the atmosphere and absorb solar radiation.

In an effort to solve this problem, U.S. Pat. No. 5,124,053 describes the use of saturated, higher fluorinated hydrofluorocabons and blends thereof with other agents for use in fire extinguishing methods and apparatus. Specifically, the use of saturated C₂ or C₃ higher fluorinated hydrocarbons of the formula CₓH_{y}F_{z}, where x is 2 or 3, y is 1 or 2, and z is 5, 6, or 7: where y is 1 and z is 5 when x is 2 and where z is 6 or 7 when x is 3. Because these compounds contain no chlorine or bromine, they have zero ozone depletion potential. The compounds are also asserted to not pose a threat as greenhouse warming gases and also have toxicity characteristics suitable for use in occupied spaces.

It is an object of the present invention to provide a fire extinguishing method that extinguishes fires as effectively as the common Halons (i.e. Halons 1301 and 1211), has similar volatility, residue levels, materials compatibility characteristics, and safety characteristics, and yet is environmentally acceptable.

It is a further object of this invention to provide blends of unsaturated perfluorocarbons with other fire extinguishing agents that share the useful properties described above but are environmentally acceptable.

These objects have been achieved with the recognition that unsaturated C₃ and C₄ perfluorocarbons are effective fire extinguishing agents at concentrations similar to those of the well-known Halons. However, these materials have no chlorine or bromine, and thus, have zero ozone depletion potential.

We have also found that because these compounds are unsaturated (i.e., a double bond between two carbon atoms), they are much less stable and are susceptible to breakdown in the lower atmosphere, and thus do not pose a threat as a greenhouse warming gas.

Specific unsaturated perfluorocarbons which are useful include compounds of the formula CₓF_{y}, where x is 3 or 4 and y is 6 or 8, respectively. Specific unsaturated perfluorocarbons which are useful include hexafluoropropene (CF₃CF═CF₂ ), octafluoro-1-butene (CF₂═CFCF₂CF₃), and octafluoro-2-butene (CF₃CF═CFCF₃).

These compounds may be used alone, in mixture with one another, or in mixture with other fire extinguishing agents or gases. These agents may be applied using the standard fire extinguishing application techniques and methods used for the standard Halons. These agents may be used in total flooding applications or systems where an entire enclosed region is subjected to the agent, or they may be used in portable fire extinguishing equipment. As will now be apparent to one skilled in the art, the agents may be pressurized with nitrogen or another inert gas to ensure adequate flow of the agent through the fire suppression system.

These agents should be used at a minimum concentration to effectively extinguish a fire. This exact concentration depends on several variables, including the exact agent or blend used, the combustion material, and the combustion of fire conditions and scenario. The best laboratory results have been found where the agent is employed at a concentration of at least 4% (v/v). The maximum concentration employed is determined, generally speaking, by economics and safety. Of course, in unoccupied areas, the maximum concentration may be increased because no living things are present.

### DETAILED DESCRIPTION OF CURRENTLY PREFERRED EMBODIMENTS

The fire suppression effectiveness of octafluoro-2-butene and hexafluoropropene were demonstrated in a dynamic test using a glass cup burner apparatus and test procedure with n-hexane and air being supplied to the burner. Vapor of the agent being tested was mixed with air and introduced to the flame. The concentration of the agent was slowly increased until the flame was extinguished; this is referred to as the flame extinguishing concentration. Table 1 provides a summary of the data for octafluoro-2-butene and hexafluoropropene and compares this data to the published values for the standard Halons and for some of the fire suppression agents described in U.S. Pat. No. 5,124,053. Table 1 shows that, in terms of flame extinguishing concentration, the compounds of this invention are more effective agents than the compounds described in U.S. Pat. No. 5,124,053 for n-heptane diffusion flames in the cup burner.

TABLE 1
Extinguishment of n-Heptane Diffusion Flame

| | | | Flame Ext. |
|---|---|---|---|
| Agent | Air Flow | Agent Flow | Conc. |
| octafluoro-2- | 20,050 cc/min | 856 cc/min | 4.0% (v/v) |
| butene¹ | | | |
| hexafluoroprop | 13,480 cc/min | 736 cc/min | 5.2% (v/v) |
| ene¹ | | | |
| CF₃CFHCF₃² | 16,200 cc/min | 1,506 cc/min | 9.3% (v/v) |
| CF₃CF₂H² | 16,200 cc/min | 1,033 cc/min | 6.4% (v/v) |
| Halon 1301³ | 16,200 cc/min | 510 cc/min | 3.1% (v/v) |
| Halon 1211³ | 16,200 cc/min | 546 cc/min | 3.4% (v/v) |

¹indicates compounds of the present invention
²indicates compounds described in U.S. Pat. No. 5,124,053
³standard commercial Halons

TABLE 2
Stability Test Results

| | | | |
|---|---|---|---|
| | Final Conc. | Initial | Percent |
| Fluid | % | Conc. (%) | change |

Test Temperature = 300 C.

| | | | |
|---|---|---|---|
| CF₃CHFCHF₂² | 99.26 | 99.29 | 0.03 |
| CF₃CFHCF₃² | 99.67 | 100.00 | 0.33 |
| CF3CH₂CF3² | 95.71 | 98.01 | 2.35 |
| Octafluoro-2-butene¹ | 96.48 | 98.99 | 2.51 |
| Hexafluoropropene¹ | 62.58 | 100.00 | 37.42 |

Test Temperature = 350 C.

| | | | |
|---|---|---|---|
| CF₃CHFCHF₂² | 97.79 | 99.29 | 1.51 |
| CF₃CFHCF₃² | 97.58 | 100.00 | 2.42 |
| CF3CH₂CF3² | 88.64 | 98.01 | 9.56 |
| Octafluoro-2-butene¹ | 89.16 | 98.99 | 9.83 |
| Hexafluoropropene¹ | 5.50 | 100.00 | 94.50 |

Test Temperature = 400 C.

| | | | |
|---|---|---|---|
| CF₃CFHCF₃² | 90.05 | 100.00 | 9.95 |
| CF3CH₂CF3² | 75.24 | 98.01 | 23.23 |
| CF₃CHFCHF₂² | 71.63 | 99.29 | 27.86 |
| Octafluoro-2-butene¹ | 66.56 | 98.99 | 32.43 |
| Hexafluoropropene¹ | 0.00 | 100.00 | 100.00 |

¹indicates compounds of the invention
²indicates compounds in U.S. Pat. No. 5,124,053
* octafluoro-2-butene has 2 isomers, the percent listed is the sum of both isomers

We have also been able to demonstrate that the compounds of the present invention are much less thermally stable than the compounds in U.S. Pat. No. 5,124,053. That is, the compounds of our invention are less of a threat of being greenhouse warming gases than those of U.S. Pat. No. 5,124,053. To demonstrate this, we mixed the compound to be tested with air in a pressure cylinder to approximately 1.4% (v/v). This gas mixture was then passed over a 75 ml reactor packed with palladium (0.5% on ⅛″ alumina pellets) catalyst which was immersed in a constant-temperature bath. This system provided a minimum residence time of 2.24 seconds when the initial mixture pressure was 100 psia. The mixture was collected after passing through the reactor and analyzed on a gas chromatograph for the presence and concentration of decomposition products. Table 2 compares the results at three reactor temperatures for compounds of the present invention and compounds in U.S. Pat. No. 5,124,053 and shows that the former compounds are less thermally stable than the latter compounds, as shown by the higher values for “percent change” in Table 2. Thus, they would be less of a threat of being a greenhouse warming gas.

The residue level of octafluoro-2-butene and hexafluoropropene were experimentally measured using a method recommended by NIST (NIST Technical Note 1278). Namely, the measurement was performed by condensing about 1 cc of the agent in a crucible cooled in a dry ice/acetone bath. The crucible was cleaned and weighed prior to condensing the agent to be tested. Once the agent was transferred to the crucible, the agent was allowed to slowly evaporate. The crucible is then heated in an oven at 105° C. for 30 minutes and weighed again. The weight percent residue of the agent is then calculated from the weight of the crucible before and after the test. Octafluoro-2-butene was found to have 0.04% (w/w) residue, while hexafluoropropene was found to have 0.00% (w/w) residue. Both of these levels are acceptable for fire suppression agents (NIST Technical Note 1278).

The materials compatibility of octafluoro-2-butene and hexafluoropropene with metals and nonmetals were experimentally demonstrated and found to be acceptable. The test apparatus was a thick-walled glass pressure tube that has a glass thread at the top and a threaded plunger valve that allows for evacuating the tube and charging with another fluid under pressure. The tube was 17.8 cm in length and has an OD of 25.4 mm. The metals and nonmetals tested were Nitronic 40, copper CDA 172, aluminum 6061-T6, 1020 alloy steel, Teflon TFE, silicon rubber, Buna-N, and Viton. Circular coupons of these materials have been procured that measure ½″ OD, 1/16″ thick, with a 9/64″ OD hole in the center. A Teflon rod passed through this hole and suspends the coupon, small Teflon spacers separate the coupons on the Teflon rod. Two coupons from each material are mounted on the Teflon rod and placed in the test container. The tube with the test samples is then evacuated and charged with candidate agent so that each of the test coupons is covered with liquid agent. The test time has been set at one month, and the test temperature has been set at room temperature.

Each metal coupon is cleaned ultrasonically with acetone and isopropanol, dried, and weighed to the nearest 0.1 mg prior to mounting on the Teflon rod. After the test, the metal coupons are cleaned, examined under a microscope, and weighed to determine the corrosion rate according to the equation below.

$$corrosion rate ( \frac{mil}{year} ) = \frac{345 \times {10}^{6} ( {w}_{i} - {w}_{f} )}{Atd}$$

where:

wᵢ=initial weight (g)

W_{f}=final weight (g)

A=area of coupon (in²)

t=time (h)

D=metal density (g/ml)

The nonmetal samples are cleaned prior to the test in a soap/water solution, dried, and weighed to the nearest 0.1 mg prior to mounting on the Teflon rod. After the test, the nonmetal coupons are cleaned, examined under a microscope, and their dimensions are measured with a micrometer to determine if any swelling occurred.

Tables 3 and 4 present the results of these materials compatibility tests. The corrosion rates listed are average values for the two metal samples of each material. The values with a “less-than” (“<”) correspond to a mass change less than the sensitivity of our balance (±0.1 mg). Table 4 presents the results of the materials compatibility tests for the nonmetal samples tested. A compatibility rating was defined based on the percentage change in the thickness of the sample before and after the test. Mass changes and diameter changes of the sample were also measured during the test, and were found to correlate highly with the change in sample thickness. Percent mass changes correlated to percent thickness changes by an average factor of 6.1 (R²=0.96), percent diametric changes correlated to percent thickness changes by an average factor of 0.57 (R²=0.92).

TABLE 3
Corrosion Rates (mm/year × 10⁴)

| | | | Cu CDA | Nitronic |
|---|---|---|---|---|
| | 1020 Steel | Al 6061-T6 | 172 | 40 |
| octafluoro-2-butene | 48.4 | 106 | 184 | 96.9 |
| hexafluoropropene | <1.85 | 53.2 | 54.0 | 7.21 |

TABLE 4
Materials Compatibility Results For Nonmetals

| | | Silicon | | |
|---|---|---|---|---|
| | Buna-N | Rubber | Viton | Teflon |
| octafluoro-2-butene | B | C | B | A |
| hexafluoropropene | A | C | B | B |

A: negligible effect (0-2% thickness change)
B: minor effect (2-5% thickness change)
C: moderate effect (5-15% thickness change)
D: severe effect (>15% thickness change and/or breakage)

The short-term toxicity characteristics of octafluoro-2-butene were also experimentally demonstrated. In this test, 10 rats were exposed to approximately 9% (v/v) of the agent, which is approximately twice the flame extinguishing concentration in the cup burner. The exposure time was 15 minutes, plus a 23-minute time for the chamber concentration to reach equilibrium. This time is well in excess of the time required to evacuate a room or other enclosed facility where an agent is dispersed to fight a fire. After the exposure period, each of the animals was returned to the cage and observed for 14 days. All animals survived the exposure to the test atmosphere. This test showed that the 15-minute lethal concentration (LC₅₀) of this agent is greater than 9% (v/v).

Although the invention has been described and illustrated in detail, it is to be clearly understood that the same is by way of illustration and example, and is not to be taken by way of limitation. The spirit and scope of the present invention are to be limited only by the terms of the appended claims.

What is claimed is:

1. A method of extinguishing a fire, comprising the steps of
introducing to the fire a fire extinguishing composition consisting of at least one unsaturated perfluorocarbon compound having the formula
CₓF_{y}
where x is 3 or 4 and y is 6 or 8, respectively,
and maintaining the concentration until the fire is extinguished.

2. The method of claim 1, wherein the perfluorocarbon is selected from the group consisting of hexafluoropropene, octafluoro-1-butene, and octafluoro-2-butene.

3. The method of claim 1, wherein the composition is a mixture of at least two unsaturated perfluorocarbons.

4. The method of claim 3, wherein each of the perfluorocarbons is selected from the group consisting of hexafluoropropene, octafluoro-1-butene, and octafluoro-2-butene.

5. The method of claim 1, wherein the composition includes a mixture of conventional fire extinguishing agents.

6. The method of claim 5, wherein the perfluorocarbon is selected from the group consisting of hexafluoropropene, octafluoro-1-butene, and octafluoro-2-butene.

7. The method of claim 1, wherein the composition has a concentration level of at least about 4% (v/v).

8. The method of claim 1, wherein the step of introducing comprises total flooding.

9. The method of claim 1, wherein the step of introducing occurs in an enclosed region.

10. The method of claim 1, wherein the step of introducing includes using an inert gas to pressurize the composition sufficiently to maintain an adequate flow of the composition toward the fire.

11. The method of claim 1, wherein the composition has low thermal stability.

12. The method of claim 1, wherein the perfluorocarbon compound has a residue of no more than about 1.00% (w/w).

13. The method of claim 1, wherein the perfluorocarbon compound is compatible with metals and nonmetals.

14. The method of claim 1, wherein the perfluorocarbon compound does not exhibit short-term toxicity.

15. The method of claim 4, wherein the composition has a concentration level of at least about 4% (v/v).

16. The method of claim 15, wherein the step of introducing includes using an inert gas to pressurize the composition sufficiently to maintain an adequate flow of the composition toward the fire.

17. The method of claim 1, wherein the step of introducing includes providing the composition in a portable fire extinguisher.

18. The method of claim 17, wherein the perfluorocarbon is selected from the group consisting of hexafluoropropene, octafluoro-1-butene, and octafluoro-2-butene.

19. The method of claim 18, wherein the step of introducing includes using an inert gas to pressurize the composition sufficiently to maintain an adequate flow of the composition toward the fire.

20. The method of claim 18, wherein the perfluorocarbon compound has a residue of no more than about 1.00% (w/w).

21. A method of using at least one unsaturated perfluorocarbon having the formula CₓF_{y}, where x is 3 or 4 and y is 6 or 8, respectively, for extinguishing fires.

22. The method of claim 21, wherein the perfluorocarbon is selected from the group consisting of hexafluoropropene, octafluoro-1-butene, and octafluoro-2-butene.

23. A composition consisting of at least one unsaturated perfluorocarbon having the formula CₓF_{y}, where x is 3 or 4 and y is 6 or 8, respectively, at a concentration level sufficient to extinguish a fire.

24. The method of claim 23, wherein the perfluorocarbon is selected from the group consisting of hexafluoropropene, octafluoro-1-butene, and octafluoro-2-butene.

25. The composition according to claim 23, wherein the concentration level is at least about 4% (v/v).

26. The composition according to claim 23, wherein the perfluorocarbon compound has a residue of no more than about 1.00% (w/w).
